(19) United States
(12) Patent Application Publication
(10) Pub. No.: US 2016/0169723 A1
(43) Pub. Date: Jun. 16, 2016

(54) MASS AIRFLOW METER

(71) Applicant: YOW JUNG ENTERPRISE CO., LTD., KAOHSIUNG CITY (TW)

(72) Inventor: SHUN-CHI HUANG, KAOHSIUNG CITY (TW)

(21) Appl. No.: 14/568,360

(22) Filed: Dec. 12, 2014

(51) Int. Cl. G01F 1/76; G01M 15/04

(52) U.S. Cl. CPC G01F 1/76; G01M 15/042

(57) ABSTRACT

A mass airflow meter is installed in the main intake passage of an internal combustion engine (ICE) and comprises an auxiliary passage and two sensors positioned in the auxiliary passage. The two sensors are connected to a control circuit which controls the air intake based on results measured by the sensors. The auxiliary passage comprises three paths. The first and third paths are paralleled and interconnected with each other through the second path positioned above them. An entrance of the first path is lower than that of the third path, thereby reducing the mixed flow of air and increasing the air flow rate through the guide of the auxiliary passage. The accuracy of the measurement of the air intake is increased by the sensors positioned correspondingly to the entrance of the first and third path to increase the fuel and air combustion efficiency is to elevate the horsepower of the ICE.

### BACKGROUND OF THE INVENTION

1. Field of the Invention

The present invention relates a mass airflow meter. More particularly, a mass airflow meter increases the accuracy of the measurement of air intake and elevates the horsepower of the internal combustion engine.

2. Description of Related Art

Internal combustion engine is a device which can transform chemical energy into mechanical energy. In the internal combustion engine, it mainly makes that the fuel is mixed with the air and then combusted to produce heat, and because of heat the gas is expanded to raise the gas pressure. The high-pressure gas triggers the machine apply force to some component of the engine for transforming chemical energy into mechanical energy. In order to keep the operation of the internal combustion engine, it is must continue to be the intake and exhaust cycles. In the other words, it continuously intakes the fresh gas and exhausts the combustion gas. Therefore, an intake system is installed at an air-inlet end of the internal combustion engine, and an exhaust system is installed at the exhaust end of the internal combustion engine.

In the intake system installed in a vehicle, the air flowing into the main intake passage is filtered by the air cleaner first, then flows through a mass airflow meter, throttle, etc, and finally enters the internal combustion engine to perform the transformation between chemical energy and mechanical energy described above. The ratio of the amount of the air flowing into the internal combustion engine to the fuel is a key point to influence the work of the internal combustion engine. Therefore, the mass airflow meter is utilized to detect the air intake, and the detection result is sent to an electronic control unit. The electronic control unit calculates the amount of the fuel injected based on the detection result.

If the mass airflow meter losses the accuracy of the measurement of air intake, it may causes unstable engine revolution under vehicle idling, even causes the internal combustion engine stall. In addition, because the air intake can not be correctly detected, the combustion efficiency is decreased sharply to cause the power of the internal combustion engine reduce, simultaneously, due to incomplete combustion, the black smoke is discharged to cause air pollution.

Please refer to the US Patent application with the Issue No. 5789673. An air flow measuring instrument is disclosed and provided with an auxiliary passage in the instrument body. The auxiliary passage includes at least one bent portion composed of a first path and a second path. A first sensor and a second sensor are interval positioned in the first path, and the second sensor is corresponded to the second path. The sensors detect the air flowing into the auxiliary passage, and the detection result is sent to an electronic control unit. The electronic control unit calculates the amount of the fuel injected based on the detection results.

In actually use, the air flow measuring instrument provided in the US patent application with the Issue No. 5789673 can detect the air intake, but the accuracy of the first and the second sensor is not well due to the type of the auxiliary passage and the position of the first and second path. Therefore, it is can not accurately control the fuel supply to result in poor fuel and air combustion efficiency of the internal combustion engine. The horsepower of the internal combustion engine is decreased to cause powerless during the vehicle acceleration.

### SUMMARY OF THE INVENTION

The object of the present invention is to provide a mass airflow meter for effectively increasing the accuracy of the measurement of air intake and elevating the horsepower of the internal combustion engine.

For the above object, a mass airflow meter comprises an auxiliary passage, comprising a first path, a second path, and a third path. The first and third paths are paralleled and interconnected with each other through the second path positioned above them. An entrance of the first path is lower than an entrance of the third path, and the cross sectional area of the first path is smaller than the cross sectional area of the third path. At least two sensors are positioned in the second path and corresponded to the entrance of the firth path and the third path respectively. Results measured by the sensors are sent to an electronic control unit and the amount of fuel injected is calculated by the electronic control unit based on the results.

According to an embodiment of the present invention, the air-inlet of the auxiliary passage has an indentation area.

Therefore, the mixed flow of the air is reduced through the guide of the auxiliary passage. Simultaneously, the results measured by the sensors, which is positioned correspondingly to the entrance of the first path and the third path respectively, are sent to an electronic control unit to calculate the amount of fuel injected based on the results for increasing the accuracy of the measurement of air intake. Furthermore, when the air flows out the first path, which has smaller cross sectional area, the flow rate of the air is increased to increase combustion efficiency of the fuel and the air to promote horsepower of the internal combustion engine.

According to the above description and embodiments, the mass airflow meter of the present invention has the advantages as following:
1. Because the two sensors are positioned correspondingly to the entrance of the first path and the third path respectively, the two sensors of the mass airflow meter of the present invention can accurately measure the relevant data of the air flowing into the auxiliary passage.
2. Because the first path has smaller cross sectional area, when the air entering the auxiliary passage flows out the first path, the mass airflow meter of the present invention can raise the flow rate of the air to increase the combustion efficiency of the fuel and the air to promote the horsepower of the internal combustion engine.

### BRIEF DESCRIPTION OF THE DRAWINGS

FIG. 1 is a three-dimensional exploded view of a mass airflow meter according to an embodiment of the present invention;

FIG. 2 is a longitudinal sectional view of a mass airflow meter according to the embodiment of the present invention; and

FIG. 3 is a cross-sectional view of a mass airflow meter according to the embodiment of the present invention.

### DETAILED DESCRIPTION OF THE PREFERRED EMBODIMENT

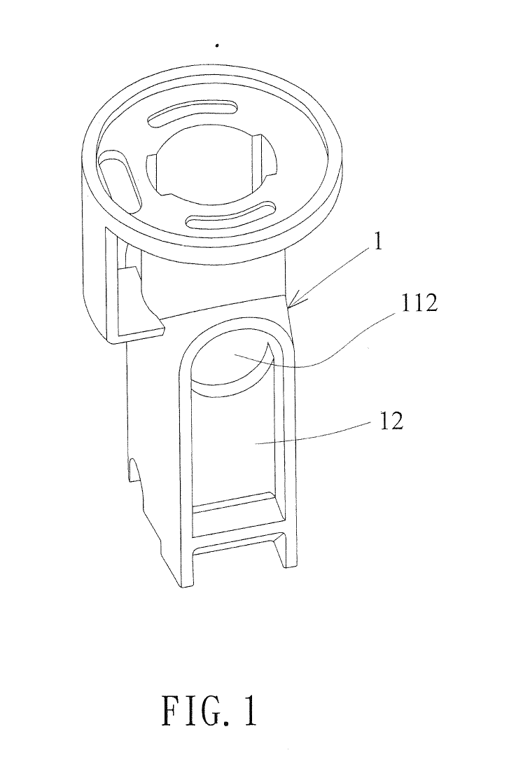

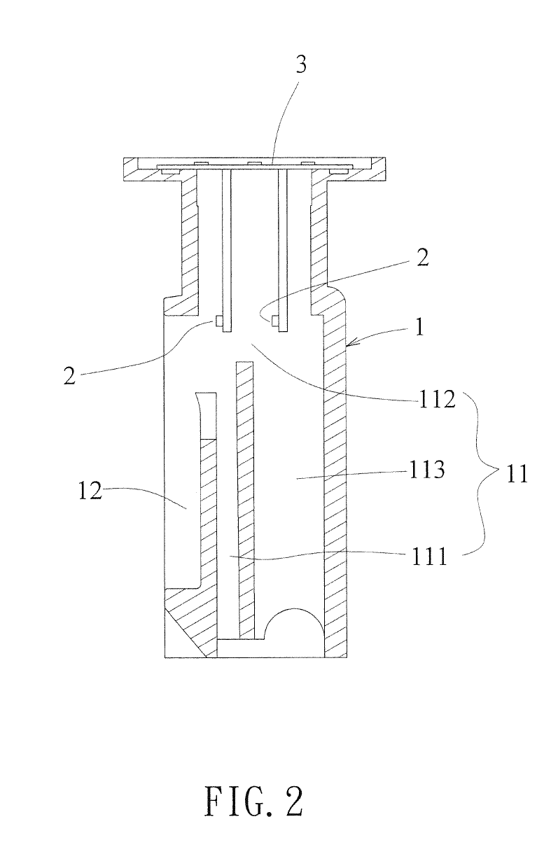

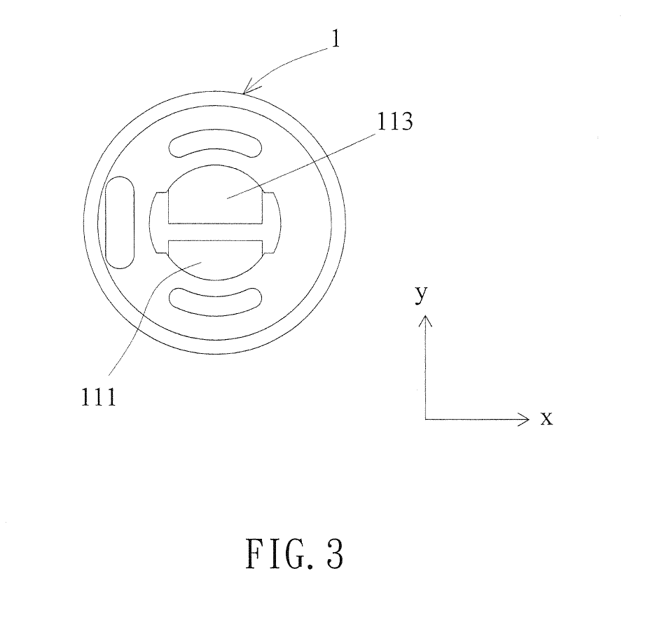

Please refer to FIG. 1 to FIG. 3, they show a three-dimensional exploded view, a longitudinal sectional view, and a cross-sectional view of a mass airflow meter according to the embodiment of the present invention respectively. The mass airflow meter is installed in the main intake passage (Not shown) of an internal combustion engine. The mass airflow meter comprises a main body 1, and the main body 1 has an auxiliary passage 11. Two sensors 2 are positioned in the auxiliary passage 11 and are electrically connected to a control circuit 3. The control circuit 3 controls the amount of the air entering the mass airflow meter of the present invention based on the results measured by the two sensors 2. The auxiliary passage 11 comprises a first path 111, a second path 112, and a third path 113. The first path 111 and the third path 113 are paralleled and interconnected with each other through the second path 112 positioned above them. An entrance of the first path 111 is lower than an entrance of the third path 113. Furthermore, under the plane formed by the definition of the first direction (x-axis) and the second direction (y-axis), the cross sectional area of the first path 111 is smaller than the cross sectional area of the third path 113. The two sensors 2 are positioned correspondingly to the entrance of the first path 111 and the third path 113 respectively. In an embodiment, an air-inlet of the auxiliary passage 11 has an indentation area 12.

In actually use the above embodiment, the air filtered by air cleaner flows into the engine through the air-intake pipe, throttle, etc. When the air flows into the mass airflow meter of the present invention from the air-intake pipe, the air enters the auxiliary passage 11 of the present invention. First, the air flows into the second path 112, and then the air is bypassed into the first path 111 and the third path 113 because the first path 111 and the third path 113 are interconnected by the second path 112. Moreover, the cross sectional area of the first path 111 is smaller than the cross sectional area of the third path 113, so the flow rate of the air flowed into the first path 111 is faster than that flowed into the third path 113, thereby reducing the mixed flow of the air. In addition, the quantity of the air flowing into the first path 111 and the third path 113 is detected by the two sensors 2 positioned correspondingly to the entrance of the first path 111 and the third path 113 respectively, thereby increasing the accuracy of the measurement of the air intake to increase combustion efficiency of the fuel and the air for promoting the horsepower of the internal combustion engine.

What is claimed is:

1. A mass airflow meter, comprising:
an auxiliary passage, comprising:
a first path;
a second path; and
a third path, parallel to the first path and interconnected with the first path through the second path positioned above the first path and the third path, wherein an entrance of the first path is lower than an entrance of the third path, and the cross sectional area of the first path is smaller than the cross sectional area of the third path; and
at least two sensors, positioned in the second path and corresponded to the firth path and the third path respectively, wherein results measured by the sensors are sent to an electronic control unit and the amount of fuel injected is calculated by the electronic control unit based on the results.

2. The mass airflow meter according to the claim 1, wherein an air-inlet of the auxiliary passage has an indentation area.
